(19) United States
(12) Patent Application Publication
(10) Pub. No.: US 2006/0252430 A1
(43) Pub. Date: Nov. 9, 2006

(54) Frequency layer dispersion

(75) Inventors: Luis Miguel Santos Barreto, Camberley (GP); Nguyen Quan Tat, Yateley (GB); Alexander Graham Charles, Fleet (GB); Richard Williams, Bagshot (GB); Timothy J. Norris, Winchester (GB); Juho Pirskanen, Tampere (FI); Christopher P. Callender, Fleet (GB)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation, Espoo (FI)

(21) Appl. No.: 11/349,053

(22) Filed: Feb. 6, 2006

Related U.S. Application Data
(60) Provisional application No. 60/651,394, filed on Feb. 8, 2005.

(51) Int. Cl. H04Q 7/20

(52) U.S. Cl. 455/450; 455/525; 455/509

(57) ABSTRACT

User Equipment (UE) in receipt of a session start signal indicating a session frequency to use for a session along with other user equipment uses the session frequency until a session stop message is received and then changes to a frequency selected to avoid subsequent use of a same frequency used by the other user equipment. For instance, when the UE receives a Multimedia Broadcast Multicast Service (MBMS) session start signal and it contains a preferred frequency, the Radio Resource Control (RRC) layer of the UE could store the frequency of the serving cell for later reference. The UE then converges to the preferred frequency for the duration of the session. When the UE receives a session stop, RRC layer retrieves the previously stored information about the pre-session frequency and requests the physical layer (L1) to select a cell on the frequency where it was previously camped on.

### FIELD OF THE INVENTION

The field of the invention is mobile communications and, more particularly, to the Universal Mobile Telecommunications System (UMTS) Terrestrial Radio Access (UTRA) of the Third Generation Partnership Project (3GPP).

### BACKGROUND OF THE INVENTION

Referring to FIG. 1, the Universal Mobile Telecommunications System (UMTS) packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network over a (wired) Iu interface.

FIG. 2 shows some further details of the architecture, particularly the UTRAN. The UTRAN includes multiple Radio Network Subsystems (RNSs), each of which contains at least one Radio Network Controller (RNC). Each RNC may be connected to multiple Node Bs which are the 3GPP counterparts to GSM base stations (a second generation Radio Access Technology (RAT)). Each Node B may be in radio contact with multiple UEs via the radio interface (Uu) shown in FIG. 1. A given UE may be in radio contact with multiple Node Bs even if one or more of the Node Bs are connected to different RNCs. For instance a UE1 in FIG. 2 may be in radio contact with Node B 2 of RNS 1 and Node B 3 of RNS 2 where Node B 2 and Node B 3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. One of the RNCs will act as the “serving” or “controlling” RNC (SRNC or CRNC) while the other will act as a “drift” RNC (DRNC). A chain of such drift RNCs can even be established to extend from a given SRNC. The multiple Node Bs will typically be neighboring Node Bs in the sense that each will be in control of neighboring cells. The mobile UEs are able to traverse the neighboring cells without having to re-establish a connection with a new Node B because either the Node Bs are connected to a same RNC or, if they are connected to different RNCs, the RNCs are connected to each other. During such movements of a UE, it is sometimes required that radio links be added and abandoned so that the UE can always maintain at least one radio link to the UTRAN. This is called soft-handover (SHO).

A Multimedia Broadcast Multicast Service (MBMS) has now been proposed for the Universal Mobile Telecommunications System (UMTS) Terrestrial Radio Access (UTRA) of the Third Generation Partnership Project (3GPP). The proposal has now evolved to include MBMS impact in reselection procedures.

3GPP Technical Specification TS 25.331 V6.4.0 (2004-12), sections 8.5 and 8.6 provide useful background; also see 3GPP TS 25.304 V.6.4.0 (2004-12). As specified therein, the User Equipment (UE) will converge to a signaled frequency upon receiving notification of an MBMS session start. However, this will result in an undesired biasing of UEs on one frequency upon session stop. This becomes particularly problematic if there are a high number of UE accesses to the network due to congestion (e.g. voice call starts, MBMS packet restoring, Packet Switched accesses, et cetera).

### SUMMARY OF THE INVENTION

An object of the present invention is to provide a solution to the above described problem that can be applied to the described situation and to similar problem situations.

When the UE receives the MBMS session start and it contains a preferred frequency, and the UE will then converge to the preferred frequency. When the UE receives a session stop, the idea is to select a frequency for subsequent use by the UE in such a way as to avoid the UE using a same frequency as other UEs.

When the UE receives the MBMS session start and it contains a preferred frequency, a way to do this is to store the frequency of the serving cell for later reference. This could be done by the Radio Resource Control (RRC) layer. The UE will then converge to the preferred frequency.

When the UE receives a session stop, RRC layer will request the physical layer (L1) to select a cell on the frequency where it was previously camped on (if different from the one where the UE is currently camped on).

The present invention discloses a solution that has a variety of advantages, including the following:
UE can quickly attempt a selection of a cell on a frequency without waiting for reselection parameters
Given that the UE was already camped on the frequency and the convergence is generally applied if there are co-located cells (ie. Equal coverage of at least 2 frequencies), in the majority of cases there will be a suitable cell to select on the stored frequency.
It does not contradict any network frequency biasing that may exist (ie.

Biasing between frequencies), therefore it does not go against operator planning and does not cause extra reselections compared to a pseudo-random selection of a frequency for camping.

It should be realized that although the present specification discloses the invention in the context of an improvement to an MBMS reselection procedure situation, the core concept is applicable to other situations in wireless interfaces and not specifically limited to MBMS and not limited to the 3GPP UTRA.

A person skilled in the art will understand that the invention summarized above can also be expressed, for example, as follows. A UE operates on a first frequency. The UE then receives an information element having preferred frequency information for a broadcast service. Therefore, the UE stores frequency information about the first frequency, and moves to the preferred frequency so that the UE receives the broadcast service. Then the UE receives an information element instructing the user equipment to release a point to multipoint radio bearer, along with an information element indicating broadcast dispersion. Thus, if a suitable cell in the first frequency is available, the user equipment selects that suitable cell. However, if the suitable cell in the first frequency is unavailable, then the user selects a cell having another frequency that is different from the first frequency and different from the preferred frequency.

### BRIEF DESCRIPTION OF THE DRAWINGS

FIG. 1 shows the prior art packet network architecture for the Universal Mobile Telecommunications System (UMTS).

FIG. 2 shows some further details of the overall architecture of the prior art UMTS.

FIG. 3 shows a simplified flow chart which may be carried out in a User Equipment (UE), according to the present invention.

FIG. 4 shows a User Equipment (UE), according to the present invention, which is able to carry out the steps illustrated in the flow chart of FIG. 3.

FIG. 5 shows a network element, according to the present invention.

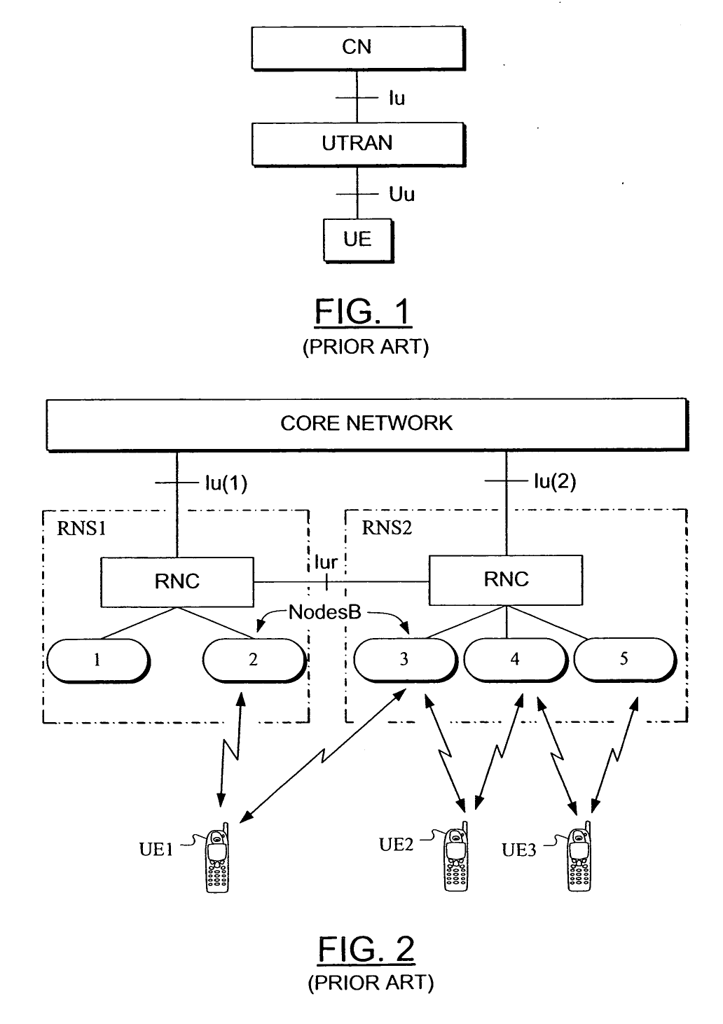

### DETAILED DESCRIPTION OF THE INVENTION

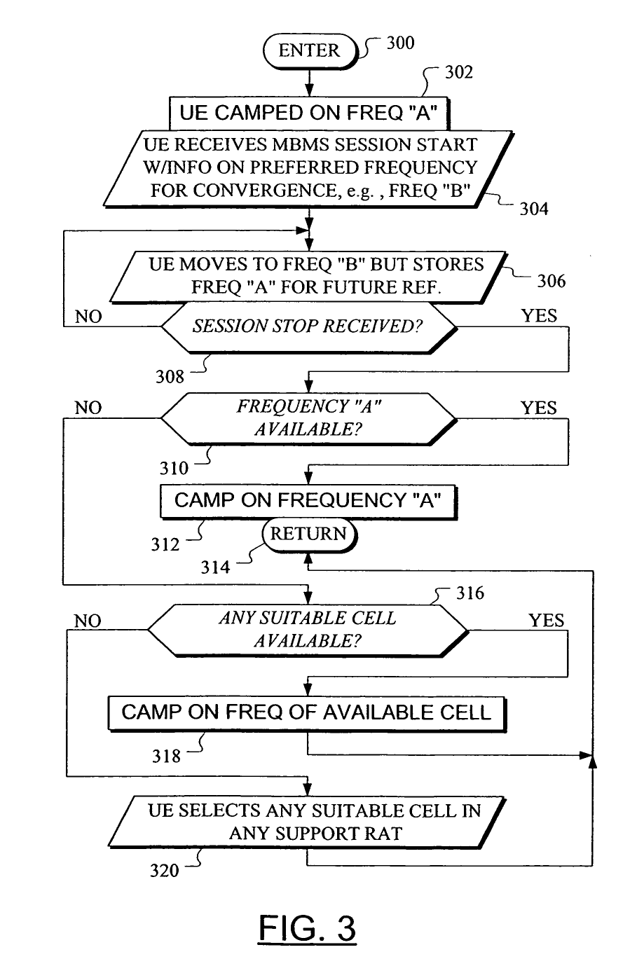

An embodiment of the present invention is shown in FIG. 3. According to that figure, after entering in a step 300, a UE is shown in a step 302 found camped on frequency “A.” In a step 304, the UE receives a MBMS session start with information on preferred frequency for convergence, say frequency “B.” The UE then moves to frequency “B” as shown in a step 306. At the same time, the UE stores the former frequency “A” for future reference. Thereafter, the UE checks in a step 308 to see if the session continues to be ongoing, i.e., if a session “stop” has been received or not. The UE receives such a session stop with a flag indicating that dispersion is required. In a step 310, the UE then tries to select a cell on the frequency where it was previously camped (i.e. frequency “A”). If the frequency “A” is found, the UE camps on frequency “A,” as shown in the step 312 and a return is made in a step 314. This is the preferred outcome where, upon session stop, the UE returns to the frequency where it was previously camped.

On the other hand if, in the step 310, the UE does not find a suitable cell on the frequency where it was previously camped, it tries to find any UTRA suitable cell, as shown in a step 316. If such a cell is found to be available, it camps on the frequency of the available cell, as shown in a step 318. If in the step 318 the UE does not find any UTRA suitable cell, it selects any suitable cell in any support RAT, as shown in a step 320 after which step a return is made in the step 314.

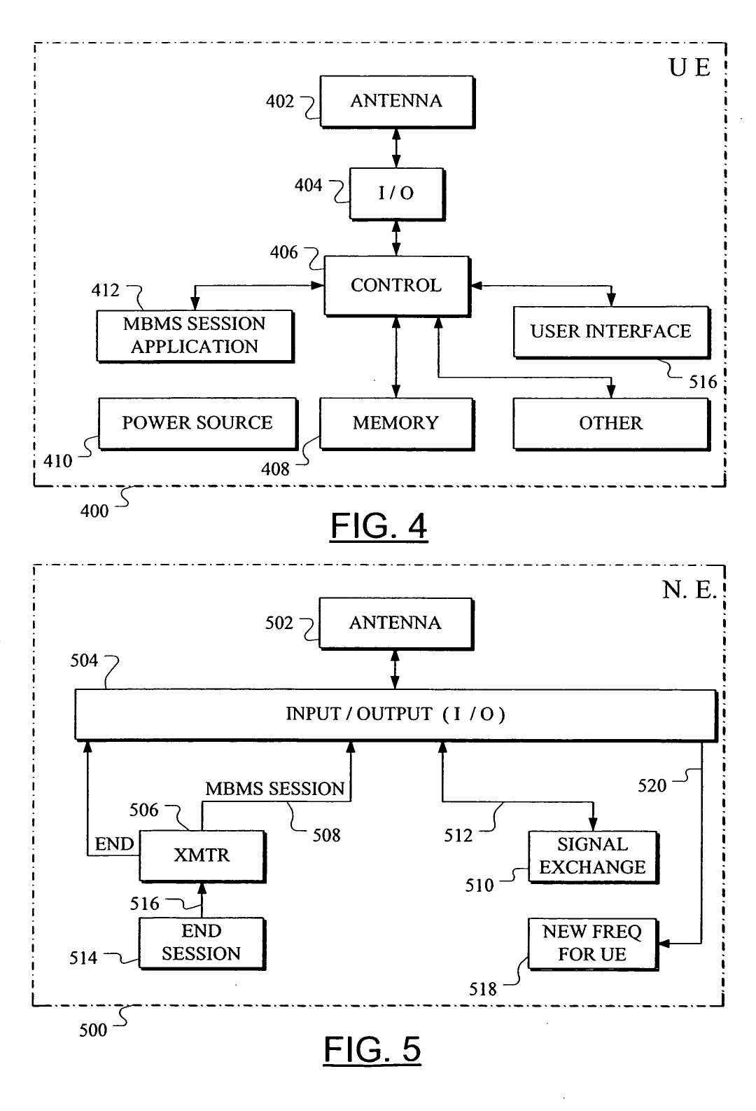

FIG. 4 shows a User Equipment (UE) 400, according to the present invention, able to carry out the steps illustrated in FIG. 3, for instance. The UE 400 includes an antenna 402 connected to an input/output device 404 which is in turn connected to a control 404. The control 406 of the UE 400 will typically be embodied as a general purpose central processing unit (CPU) or in a special purpose integrated circuit (IC) and be connected to a memory device, a source of power, a clock, various data, control and address busses, etc. The memory 408 may include both volatile and non-volatile components. The non-volatile component may include stored instructions for carrying out various application programs including an MBMS application 412. The block 412 shown in FIG. 4 is able for instance to carry out the steps shown in FIG. 3. The UE 400 may also include a user interface connected to the control 406.

There will of course be a network element involved in the reselection process and it will participate in the reselection process, more or less, depending on design choice. The network element could be the Node B or the RNC, for instance. The UE can find out from the network element information on available frequencies in the cell or cells nearby the UE and then inform the network element which frequency is selected by the UE, preferably the pre-session frequency if available. Thus, the network element will have means responsive to a signal from the UE inquiring as to the frequencies available in the cell or cells nearby the UE and will have means for sending the UE a response indicating the frequencies available for the neighboring cells. It will also have means responsive to a signal from the UE indicating which cell and which frequency has been selected.

Such a network element is shown in FIG. 5. It may be used in the reselection process involving the user equipment of FIG. 4 both before and after providing or facilitating reception by the UE of the multimedia broadcast multicast services. It may include an antenna 502 connected to an input/output device 504 connected to various devices shown as functional blocks. These may include a device 506 for sending a multimedia broadcast multicast service session signal on a line 508 to the I/O 504 for transmittal by the antenna 502 to the UE 400 for initiating a session on a frequency indicated by said MBMS signal on the line 508.

A device 510 may be provided for exchanging signals 512 with the user equipment engaged in the multimedia broadcast service session. These may be provided/received (not shown) to/from other network elements at the same or different hierarchical levels in the network. A device 514 may be provided for terminating the session by sending a stop signal on a line 516 to the user equipment 400 along with information on available frequencies in a cell or cells presently nearby the user equipment. Also shown in FIG. 5 is a device 518 for receiving information on a signal line 520 from the user equipment concerning which frequency is selected by the user equipment, preferably the pre-session frequency if available.

Although the invention has been shown and described with respect to a best mode embodiment thereof, it will be evident to those of skill in the art that various other devices and methods can be provided to carry out the objectives of the present invention while still falling within the coverage of the appended claims. It is to be understood that all of the present figures, and the accompanying narrative discussions of best mode embodiments, do not purport to be completely rigorous treatments of the invention under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. Method for execution in user equipment, comprising:
operating on a first frequency;
receiving an information element having preferred frequency information for a broadcast service;
storing frequency information about the first frequency;
moving to the preferred frequency;
receiving the broadcast service;
receiving an information element instructing the user equipment to release a point to multipoint radio bearer;
receiving an information element indicating broadcast dispersion; and
if a suitable cell in the first frequency is available, selecting the suitable cell.

2. The method of claim 1,
wherein the broadcast service is a multimedia broadcast multicast service,
wherein the cell is a Universal Mobile Telecommunications System Terrestrial Radio Access cell, and
wherein if the suitable cell in the first frequency is unavailable, then the method further comprises selecting a cell having another frequency that is different from the first frequency and different from the preferred frequency.

3. Method for execution in user equipment, comprising:
receiving, in said user equipment, a session start signal indicating a session frequency to use for a session,
saving, in said user equipment, a pre-session frequency in use by said user equipment prior to receiving said session start signal, and
using said session frequency until a session stop message is received and then retrieving said pre-session frequency saved in said step of saving and switching back to using said pre-session frequency if available.

4. Method for execution in user equipment, comprising:
receiving a session start signal indicating a session frequency to use for a session along with other user equipment, and
using said session frequency until a session stop message is received and then changing to a frequency selected to avoid subsequent use of a same frequency used by said other user equipment .

5. The method of claim 4, further comprising:
saving, in said user equipment, a pre-session frequency in use by said user equipment prior to receiving said session start signal, and
retrieving said pre-session frequency saved in said step of saving and switching back to using said pre-session frequency if available.

6. The method of claim 3, wherein if said pre-session frequency is not available, using any suitable cell frequency.

7. The method of claim 5, wherein if said pre-session frequency is not available, using any suitable cell frequency.

8. User equipment, comprising:
means for receiving a session start signal indicating a session frequency to use for a session along with other user equipment; and
means for using said session frequency until a session stop message is received and then changing to a frequency selected to avoid subsequent use of a same frequency used by said other user equipment .

9. The user equipment of claim 8, further comprising:
means for saving a pre-session frequency in use by said user equipment prior to receiving said session start signal; and
means for retrieving said pre-session frequency saved in said step of saving and switching back to using said pre-session frequency if available.

10. The user equipment of claim 8, wherein if said pre-session frequency is not available, using any suitable cell frequency.

11. User equipment, comprising:
means for receiving a session start signal indicating a session frequency to use for a session,
means for saving a pre-session frequency in use by said user equipment prior to receiving said session start signal, and
means for using said session frequency until a session stop message is received and then retrieving said pre-session frequency saved in said step of saving and switching back to using said pre-session frequency if available.

12. The user equipment of claim 11, further comprising means for using any suitable cell frequency if said pre-session frequency is not available.

13. User equipment, comprising:
means for operating on a first frequency;
receiving an information element having preferred frequency information for a broadcast service;
means for storing frequency information about the first frequency;
means for moving to the preferred frequency;
means for receiving the broadcast service;
means for receiving an information element instructing the user equipment to release a point to multipoint radio bearer;
means for receiving an information element indicating broadcast dispersion; and
means for selecting a suitable cell if the suitable cell is available in the first frequency.

14. System, comprising:
a network element; and
user equipment, the user equipment comprising:
means for receiving a session start signal from the network element, indicating a session frequency to use for a multimedia broadcast service session,
means for saving a pre-session frequency in use by said user equipment prior to receiving said session start signal, and
means for using said session frequency until a session stop message is received and then retrieving said pre-session frequency saved by said means for saving, and switching back to using said pre-session frequency if available.

15. The system of claim 14, wherein said network element comprises:
means for sending said session start signal for initiating said session on said session frequency indicated by said session start signal;
means for exchanging signals with said user equipment during said multimedia broadcast service session;
means for terminating said session by sending said session stop message to said user equipment along with information on available frequencies in a cell or cells nearby the user equipment; and
means for receiving information from said user equipment concerning which frequency is selected by the user equipment, preferably the pre-session frequency if available.

16. Network element for use in a reselection process involving user equipment receiving multimedia broadcast multicast services, comprising:
means for sending a multimedia broadcast multicast service session signal for initiating a session on a frequency indicated by said signal;
means for exchanging signals with said user equipment engaged in said multimedia broadcast service session;
means for terminating said session by sending a stop signal to said user equipment along with information on available frequencies in a cell or cells nearby the user equipment; and
means for receiving information from said user equipment concerning which frequency is selected by the user equipment, preferably the pre-session frequency if available.

17. Computer program stored on a computer-readable medium for execution in user equipment, said execution of said program comprising the steps of:
receiving, in said user equipment, a session start signal indicating a session frequency to use for a session,
saving, in said user equipment, a pre-session frequency in use by said user equipment prior to receiving said session start signal, and
using said session frequency until a session stop message is received and then retrieving said pre-session frequency saved in said step of saving, and switching back to using said pre-session frequency if available.

18. Chip hardware for executing the steps of:
receiving, in user equipment, a session start signal indicating a session frequency to use for a session,
saving, in said user equipment, a pre-session frequency in use by said user equipment prior to receiving said session start signal, and
using said session frequency until a session stop message is received and then retrieving said pre-session frequency saved in said step of saving, and switching back to using said pre-session frequency if available.
